(19) United States
(12) Patent Application Publication
(10) Pub. No.: US 2009/0161346 A1
(43) Pub. Date: Jun. 25, 2009

(54) SURFACE LIGHT SOURCE DEVICE AND LIQUID CRYSTAL DISPLAY

(75) Inventors: Gihwan AHN, Cheongju-si (KR); Akiyoshi Kanemitsu, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/341,214

(22) Filed: Dec. 22, 2008

(30) Foreign Application Priority Data
Dec. 25, 2007 (JP) 2007-331915

(51) Int. Cl. G02F 1/13357; F21V 1/00

(52) U.S. Cl. 362/97.2; 362/235

(57) ABSTRACT

The present invention provides a surface light source device capable of emitting light with high uniformity in luminance.

A surface light source device comprising a plurality of light sources spaced from one another, and a plate 3 with a light deflecting structure which is disposed on the front side of these light sources so as to change the direction of light emitted from the light sources, wherein the plate 3 with the light deflecting structure consists of a light-transmitting plate which has a relief structure 4 formed on its light outgoing surface 3b; wherein the relief structure 4 comprises a plurality of triangular ridges 6 with triangular sections projected from the plate; and wherein the slopes 14 inclined downward to the left, of the triangular ridges 6, include steep slopes 16 having an inclination angle within a specified range, and gentle slopes 17 having an inclination angle within a specified range; and the slopes 15 inclined downward to the right, of the triangular ridges, include steep slopes 16 having an inclination angle within a specified range, and gentle slopes 17 having an inclination angle within a specified range.

### BACKGROUND OF THE INVENTION

1. Field of the Invention

This application was filed claiming Paris Convention priority of Japanese Patent Application No. 2007-331915, the entire content of which is herein incorporated by reference.

The present invention relates to a surface light source device capable of emitting light with high uniformity in luminance, and to a liquid crystal display capable of displaying a picture image with high uniformity in luminance.

In this regard, “a slope inclined downward to the left” used in the specification and claims means a slope which is inclined downward to the left direction from the apex of a triangular ridge, in the sectional view of a plate with a light deflecting structure, whose light outgoing surface is faced upward; and “a slope inclined downward to the right” means a slope which is inclined obliquely and downward in the right direction from the apex of the triangular ridge, in the sectional view of the plate with the light deflecting structure, whose light outgoing surface is faced upward.

2. Description of the Related Art

For example, there is publicly known a liquid crystal display in which a surface light source device is disposed as a backlight on the lower side (or rear side) of an image-displaying member comprising a liquid crystal cell and a pair of polarizing plates disposed on both the upper and lower sides of the liquid crystal cell. As the surface light source device for use as a backlight, there is known a surface light source device which comprises a lamp box, a plurality of light sources disposed in the lamp box, and a light diffuser plate disposed on the front side of these light sources (cf. Patent Publication 1). Such a surface light source device is required to uniformly illuminate an image-displaying member.

Patent Publication 1: JP-A-7-141908/1995
(refer to Paragraph [0012] and FIG. 1)

### SUMMARY OF THE INVENTION

The distance between each of the adjacent light sources in the above-described surface light source device is preferably as long as possible, because the number of the light sources can be decreased for power reduction. The distance between the light sources and the light diffuser plate is preferably as short as possible, to provide a liquid crystal display with a further decreased thickness.

However, the conventional surface light source device as described above has difficulties in that light from the plurality of light sources can not be sufficiently diffused by the light diffuser plate, because of the long distance between each of the light sources or because of the short distance between the light sources and the diffuser plate. Thus, such a surface light source device suffers from nonuniformity in luminance.

The present invention is developed to overcome the problem of the prior art, and an object thereof is therefore to provide a surface light source device capable of emitting light with high uniformity in luminance. Another object of the present invention is to provide a liquid crystal display capable of displaying a high quality picture image with high uniformity in luminance.

To achieve the above-described objects, the present invention provides the following means.

[1] A surface light source device comprising a plurality of light sources spaced from one another, and a plate with a light deflecting structure which is disposed on the front side of the light sources to change the direction of light emitted from the light sources, characterized in that
said plate with the light deflecting structure consists of a light-transmitting plate having a relief structure formed on its light outgoing surface, said relief structure comprising a plurality of triangular ridges with triangular sections;
said triangular ridges have slopes inclined downward to the left and slopes inclined downward to the right,
said slopes inclined downward to the left including steep slopes satisfying a relationship of

α−3°≦X≦α+3°,

wherein “X” is an inclination angle (an acute angle) of the slope inclined downward to the left, relative to the light incoming surface; and α is an angle determined by the following equation (1), and
gentle slopes satisfying a relationship of

β−3°≦X≦β+3°,

wherein β is an angle determined by the following equation (3); and
said slopes inclined downward to the right including steep slopes satisfying a relationship of

α−3°≦Y≦α+3°,

wherein “Y” is an inclination angle (an acute angle) of the slope inclined downward to the right, relative to the light incoming surface, and
gentle slopes satisfying a relationship of

β−3°≦Y≦β+3°,

$$\begin{matrix}[ Equation 5 ] & \\ α = {Tan}^{- 1} ( \frac{sin {j}_{a}}{cos {j}_{a} - 1 / n} ) & ( 1 )\end{matrix}$$

(wherein jₐ is an angle satisfying the following equation (2)):

$$\begin{matrix}[ Equation 6 ] & \\ {Sin}^{- 1} ( n \cdot sin {j}_{a} ) = {Tan}^{- 1} \{ \frac{1}{d} ( \frac{3 L}{8} - t \cdot tan {j}_{a} ) \} & ( 2 ) \\ [ Equation 7 ] & \\ β = {Tan}^{- 1} ( \frac{sin {j}_{b}}{cos {j}_{b} - 1 / n} ) & ( 3 )\end{matrix}$$

(wherein j_{b} is an angle satisfying the following equation (4)):

$$\begin{matrix}[ Equation 8 ] & \\ {Sin}^{- 1} ( n \cdot sin {j}_{b} ) = {Tan}^{- 1} \{ \frac{1}{d} ( \frac{L}{8} - t \cdot tan {j}_{b} ) \} & ( 4 )\end{matrix}$$

(wherein, in the equations (1) to (4), n is the refractive index of the triangular ridge; L is the distance between each of the centers of the light sources adjacent to each other; d is the distance between the centers of the light sources and the light incoming surface of the plate with the light deflecting structure; and t is the thickness of the plate with the light deflecting structure).
[2] The surface light source device of the item 1, characterized in that the following relationship is satisfied:

0.9≦Sa/Sb≦3.0,

wherein “Sa” is the total of projected areas found when the steep slopes are projected to the light incoming surface; and “Sb” is the total of projected areas found when the gentle slopes are projected to the light incoming surface.
[3] The surface light source device of the item 1 or 2, characterized in that the following relationship is satisfied:

0.9≦E/F≦1.1,

wherein

“E” is the total of projected areas found when the steep slopes out of the slopes inclined downward to the left of the triangular ridges are projected to the light incoming surface; and

“F” is the total of projected areas found when the steep slopes out of the slopes inclined downward to the right of the triangular ridges are projected to the light incoming surface; and

the following relationship is satisfied:

0.9≦G/H≦1.1,

wherein

“G” is the total of projected areas found when the gentle slopes out of the slopes inclined downward to the left of the triangular ridges are projected to the light incoming surface; and

“H” is the total of projected areas found when the gentle slopes out of the slopes inclined downward to the right of the triangular ridges are projected to the light incoming surface.

[4] The surface light source device of any one of the items 1 to 3, wherein a projected length is from 10 to 500 μm, which is found when the length of the slope inclined downward to the left in the inclining direction, of the triangular ridge is projected to the light incoming surface; and a projected length is from 10 to 500 μm, which is found when the length of the slope inclined downward to the right in the inclining direction, of the triangular ridge is projected to the light incoming surface.
[5] The surface light source device of any one of the items 1 to 4, wherein said plate with the light deflecting structure contains light diffuser particles, and the light incoming surface of said plate with the light deflecting structure is formed smooth.
[6] The surface light source device of any one of the items 1 to 4, wherein the light incoming surface of said plate with the light deflecting structure is matted.
[7] A liquid crystal display, characterized in that a surface light source device defined in any one of the items 1 to 6 is disposed on the rear side of a liquid crystal panel.

In the invention [1], the triangular ridges have the slopes inclined downward to the left and the slopes inclined downward to the right; and the slopes inclined downward to the left include the steep slopes satisfying a relationship of α−3°≦X≦α+3°, wherein “X” is an inclination angle (an acute angle) of the slope inclined downward to the left, relative to the light incoming surface of the plate with the light deflecting structure, and the gentle slopes satisfying a relationship of β−3°≦X≦β+3°; and the slopes inclined downward to the right include the steep slopes satisfying a relationship of α−3°≦Y≦α+3°, wherein “Y” is an inclination angle (an acute angle) of the slope inclined downward to the right, relative to the light incoming surface of the plate with the light deflecting structure, and the gentle slopes satisfying a relationship of β−3°≦Y≦β+3°. Therefore, the luminance of the surface light source device in substantially the forward direction can be increased, and the uniformity in luminance can be improved. Further, substantially no images of the linear light sources is observed. Furthermore, the molding of the plate with the light deflecting structure becomes easy, because the relief structure comprises triangular ridges.

In the present invention, the slopes inclined downward to the left include the steep slopes having the above-specified angle, and the gentle slopes having the above-specified angle; and the slopes inclined downward to the right include the steep slopes having the above-specified angle, and the gentle slopes having the above-specified angle. Therefore, there are obtained four light source images (or lamp images), for example, between each of the light sources adjacent to each other. That is, four different slopes (i.e., a steep slope inclined downward to the left, a steep slope inclined downward to the right, a gentle slope inclined downward to the left, and a gentle slope inclined downward to the right) correspond to each of the light sources. In the present invention, designing is made so that the four light source images can be formed (or distributed) substantially evenly (or at substantially even intervals), in order to emit uniform light with high uniformity in luminance. The angles of α and β are so determined as to allow the four light source images to be distributed at perfectly even intervals between each of the light sources adjacent to each other. In addition, four light source images distributed at substantially even intervals are also included by broadening the ranges of the angles of X and Y to α±3° and β±3°, respectively.

In the invention [2], the following relationship is satisfied: 0.9≦Sa/Sb≦3.0, wherein “Sa” is the total of the projected areas found when the steep slopes are projected to the light incoming surface; and “Sb” is the total of the projected areas found when the gentle slopes are projected to the light incoming surface. In comparison between a steep slope and a gentle slope, outgoing light is focused to form a light source image at a position on the steep slope, farther from a light source than a position on the gentle slope, so that the light intensity is relatively lower. Accordingly, it is desirable that light with equal to or larger intensity than that on the gentle slope should income to the steep slope. In the invention [2], the relationship of 0.9≦Sa/Sb≦3.0 is satisfied in order that light with equal to or larger intensity than that on the gentle slope can income to the steep slope. Accordingly, it becomes possible to further uniform the luminances of the respective light source images, so that the surface light source device can emit uniform light with high uniformity in luminance.

In the invention [3], the steep slopes inclined at the above-specified angles are formed at substantially the same proportions with respect to the slopes inclined downward to the left and the slopes inclined downward to the right; and the gentle slopes inclined at the above-specified angles are also formed at substantially the same proportions with respect to the slopes inclined downward to the left and the slopes inclined downward to the right. Therefore, it becomes possible to sufficiently suppress nonuniformity in luminance.

In the invention [4], it becomes possible to non-visualize the projected lines which run along the vertexes of the triangular ridges in visual observation.

In the invention [5], the plate with the light deflecting structure contains light diffuser particles, and the light incoming surface of the plate with the light deflecting structure is formed smooth. Therefore, it becomes possible to further improve the luminance of the surface light source device in the substantially forward direction, and also to further sufficiently suppress nonuniformity in luminance.

In the invention [6], the light incoming surface of the plate with the light deflecting structure is matted. Therefore, it becomes possible to further improve the luminance of the surface light source device in the substantially forward direction, and also to further sufficiently suppress nonuniformity in luminance.

In the invention [7], it becomes possible to provide a liquid crystal display capable of displaying a high quality picture image with high luminance and less nonuniformity in luminance.

### BRIEF DESCRIPTION OF THE DRAWINGS

FIG. 1 is a schematic diagram illustrating an example of a liquid crystal display according to the present invention.

FIG. 2 is a perspective view of a plate with a light deflecting structure used in the liquid crystal display shown in FIG. 1.

FIG. 3 is a sectional view of the plate with the light deflecting structure shown in FIG. 2 (a first embodiment).

FIG. 4 is a sectional view of a plate with other light deflecting structure (a second embodiment).

FIG. 5 is a sectional view of a plate with other light deflecting structure (a third embodiment).

FIG. 6 is a sectional view of a plate with other light deflecting structure (a fourth embodiment).

FIG. 7 is a sectional view of a plate with other light deflecting structure (a fifth embodiment).

FIG. 8 is a sectional view of a plate with other light deflecting structure (a sixth embodiment).

FIG. 9 is a sectional view of a plate with other light deflecting structure (a seventh embodiment).

FIG. 10 is a sectional view of a plate with other light deflecting structure (an eighth embodiment).

FIG. 11 is a sectional view of a plate with other light deflecting structure (a ninth embodiment).

FIG. 12 is a schematic plan view showing an example of four light source images (or lamp images) between each of the light sources adjacent to each other.

1=a surface light source device
2=a light source
3=a plate with a light deflecting structure
3a=a rear side (i.e., a light incoming surface)
3b=a front side (i.e., a light outgoing surface)
4=a relief structure
6=a triangular ridge
14=a slope inclined downward to the left
15=a slope inclined downward to the right
16=a steep slope
17=a gentle slope
20=a liquid crystal panel
30=a liquid crystal display
X=an inclination of the slope inclined downward to the left
Y=an inclination of the slope inclined downward to the right
Sa=a projected area found when the steep slope is projected to the light incoming surface
Sb=a projected area found when the gentle slope is projected to the light incoming surface
E=a projected area found when the steep slope, out of the slopes inclined downward to the left, is projected to the light incoming surface
F=a projected area found when the steep slope, out of the slopes inclined downward to the right, is projected to the light incoming surface
G=a projected area found when the gentle slope, out of the slopes inclined downward to the left, is projected to the light incoming surface
H=a projected area found when the gentle slope, out of the slopes inclined downward to the right, is projected to the light incoming surface
Ua=a projected length found when the length of the slope inclined downward to the left in the inclining direction is projected to the light incoming surface
Ub=a projected length found when the length of the slope inclined downward to the right in the inclining direction is projected to the light incoming surface
n=a triangular ridge
L=a distance between each of the centers of the light sources adjacent to each other
d=a distance between the centers of the light sources and the light incoming surface of the plate with the light deflecting structure
t=the thickness of the plate with the deflecting structure (i.e., a minimum value of the distance between the light incoming surface and the light outgoing surface (a minimum interval))

### DETAILED DESCRIPTION OF THE INVENTION

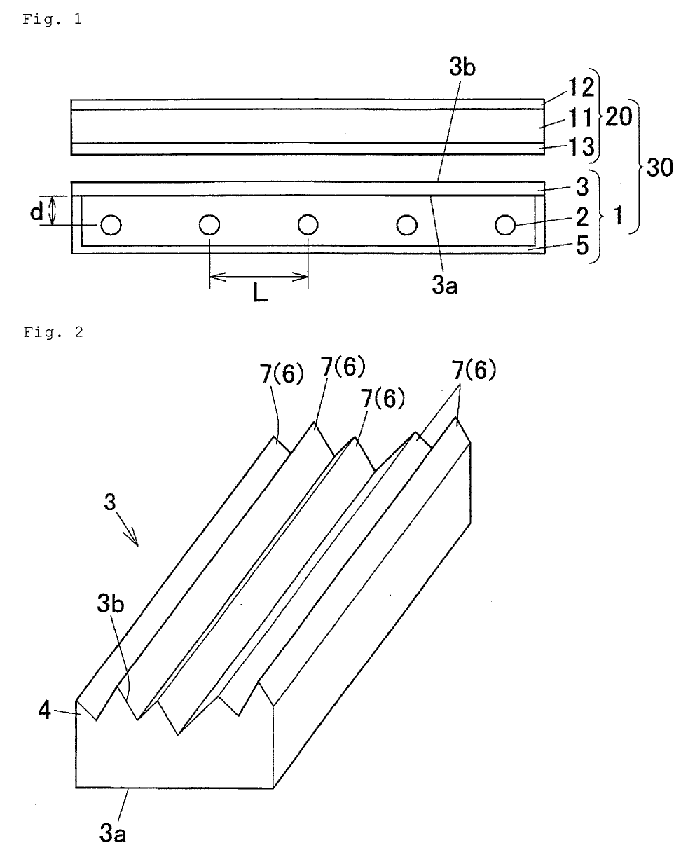

An embodiment of a liquid crystal display according to the present invention is shown in FIG. 1, in which (30) refers to a liquid crystal display; (11), to a liquid crystal cell; (12) and (13), to polarizing plates; and (1), to a surface light source device (or a backlight). The polarizing plates (12) and (13) are disposed on both the upper and lower sides of the liquid crystal cell (11), respectively, so that these members (11), (12) and (13) constitute a liquid crystal panel (20).

The surface light source device (1) is disposed on the lower side of the lower polarizing plate (13) of the liquid crystal panel (20). The surface light source device (1) comprises a lamp box (5) which is rectangular in plan view and is opened at its upper side (or front side), a plurality of linear light sources (2) which are spaced from one another in the lamp box (5), and a plate (3) with a light deflecting structure, which is disposed above the plurality of linear light sources (2) (or in front thereof). The plate (3) with the light deflecting structure is fixed to the lamp box (5) to close the opening of the lamp box (5). The lamp box (5) is lined at its interior with a light-reflecting layer (not shown).

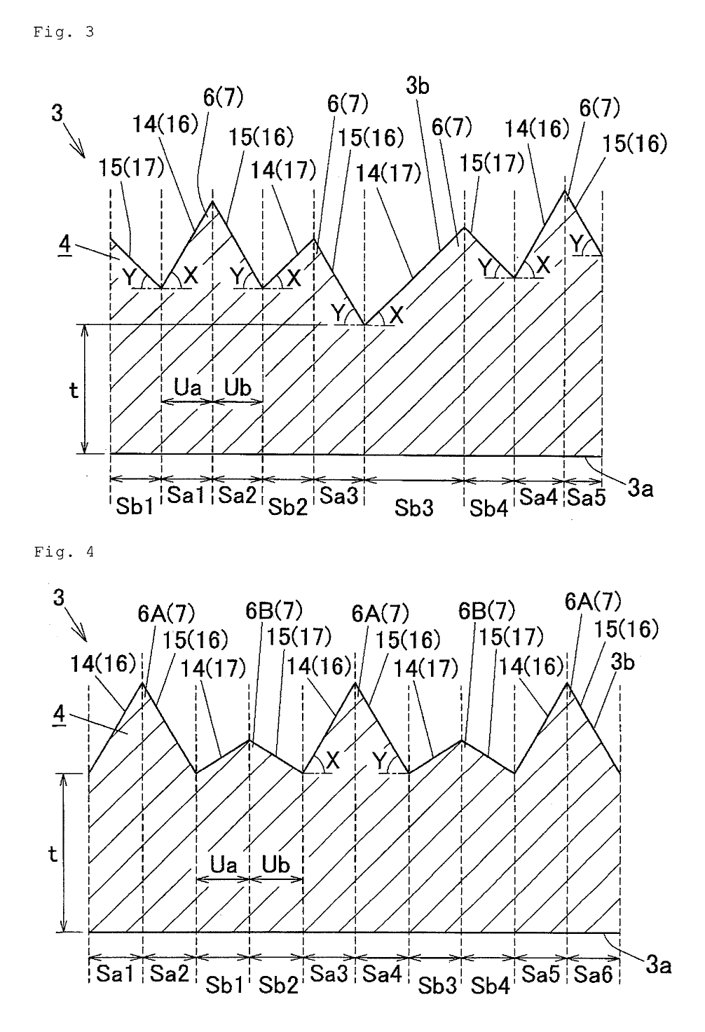

As shown in FIGS. 2 and 3, the plate (3) with the light deflecting structure consists of a light-transmitting plate which has a relief structure (4) formed on its one surface (light outgoing surface) (3b). The relief structure (4) comprises a plurality of triangular ridges (6) having triangular sections. The other surface (light incoming surface) (3a) of the plate (3) with the light deflecting structure is formed smooth. The plate (3) with the light deflecting structure functions to change the direction of light incoming to the light incoming surface (3a) thereof and then to allow the light to outgo from the light outgoing surface (3b) thereof.

The plate (3) with the light deflecting structure is disposed so that its light outgoing surface (3b) having the relief structure (4) formed thereon can be located on the front side (on the side of the liquid crystal panel) (see FIG. 1). In other words, the plate (3) is disposed so that its surface (3a) having no relief structure (4) formed thereon (i.e., its light incoming surface) can be located on the rear side (on the side of the light sources) (see FIG. 1).

In this embodiment, the triangular ridges (6) are formed as triangular ridges (7) having triangular sections, which extend along one direction in parallel to the surface of the plate (3) with the light deflecting structure, so that the plurality of the triangular ridges (7) can be substantially in parallel to one another in their lengthwise directions (see FIG. 2).

In this embodiment, linear light sources are used as the above-described light sources (2). The linear light sources (2) are so disposed that their lengthwise directions can be substantially in conformity with the lengthwise directions of the ridges (7) of the plate (3) with the light deflecting structure.

However, in the present invention, such a structure that satisfy the following relationships is employed: that is, the triangular ridges (6) have the slopes (14) inclined downward to the left, and the slopes (15) inclined downward to the right; the slopes (14) inclined downward to the left include

steep slopes (16) which satisfy the following relationship, relative to an angle of α determined by the following equation (1), wherein “X” represents an inclination (an acute angle) of the slope (14) inclined downward to the left, to the light incoming surface (3a):

α−3°≦X≦α+3°, and

gentle slopes (17) which satisfy the following relationship, relative to an angle of β determined by the following equation (3):

α−3°X≦β+3°; and

the slopes (15) inclined downward to the right include

steep slopes (16) which satisfy the following relationship, relative to an angle of αdetermined by the following equation (1), wherein “Y” represents an inclination (an acute angle) of the slope (15) inclined downward to the right, to the light incoming surface (3a):

α−3°≦Y≦α+3°, and

gentle slopes (17) which satisfy the following relationship, relative to an angle of β determined by the following equation (3):

β−3°≦Y≦β+3°:

$$\begin{matrix}[ Equation 9 ] & \\ α = {Tan}^{- 1} ( \frac{sin {j}_{a}}{cos {j}_{a} - 1 / n} ) & ( 1 )\end{matrix}$$

(wherein jₐ is an angle satisfying the following equation (2)):

$$\begin{matrix}[ Equation 10 ] & \\ {Sin}^{- 1} ( n \cdot sin {j}_{a} ) = {Tan}^{- 1} \{ \frac{1}{d} ( \frac{3 L}{8} - t \cdot tan {j}_{a} ) \} & ( 2 ) \\ [ Equation 11 ] & \\ β = {Tan}^{- 1} ( \frac{sin {j}_{b}}{cos {j}_{b} - 1 / n} ) & ( 3 )\end{matrix}$$

(wherein j_{b} is an angle satisfying the following equation (4)):

$$\begin{matrix}[ Equation 12 ] & \\ {Sin}^{- 1} ( n \cdot sin {j}_{b} ) = {Tan}^{- 1} \{ \frac{1}{d} ( \frac{L}{8} - t \cdot tan {j}_{b} ) \} & ( 4 )\end{matrix}$$

(wherein, in the equations (1) to (4), n is the refractive index of the triangular ridge; L is the distance between each of the centers of the light sources adjacent to each other; d is the distance between the centers of the light sources and the light incoming surface of the plate with the light deflecting structure; and t is the thickness of the plate with the light deflecting structure).

In this embodiment (i.e., a first embodiment), the plate (3) with the light deflecting structure has the above-described steep slopes (16) and the above-described gentle slopes (17) which are disposed irregularly on its light outgoing surface (3b) (see FIG. 3).

In the surface light source device (1) with the above-described structure, four light source images (or lamp images) (40) are obtained between each of the light sources (2) adjacent to each other, corresponding to four different slopes (a steep slope inclined downward to the left, a steep slope inclined downward to the right, a gentle slope inclined downward to the left, and a gentle slope inclined downward to the right) (see FIG. 12). In the present invention, designing is made so that these four light source images can be formed (or distributed) substantially evenly (at substantially even intervals), in order that the surface light source device can emit uniform light with high uniformity in luminance. That is, the angles of α and β are determined so that the four light source images (40) between each of the light sources (2) adjacent to each other can be distributed at perfectly even intervals. In addition to such perfectly even arrangement of the light source images, substantially even arrangement thereof is included by broadening the ranges of the above-described inclinations (acute angles) X and Y to α±3° and β±3°, respectively. Consequently, the surface light source device (1) can emit uniform light with high uniformity in luminance toward the liquid crystal panel (20), while increasing the luminance of the light substantially in the forward direction.

Further, the manufacturing of the surface light source device (1) is comparatively easy, and thus, the productivity thereof is excellent, since the relief structure (4) thereof comprises the triangular ridges (6).

Furthermore, according to the above-described surface light source device (1), as is apparent from Examples described later, uniform light with high uniformity in luminance can be emitted, even with an arrangement wherein the distance (L) between each of the centers of the light sources (2), (2) adjacent to each other is from 10 to 70 mm; and the distance (d) between the center of the light source (2) and the light incoming surface (3a) of the plate (3) with the light deflecting structure is from 2 to 30 mm. Consequently, the light sources to be disposed in the surface light source device (1) of the present invention can be decreased in number, in comparison with the conventional surface light source devices, and thus can contribute to power reduction. Further, the distance between the light sources (2) and the plate (3) with the light deflecting structure can be reduced, and thus, it certainly becomes possible to provide a surface light source device with a decreased thickness.

In the present invention, preferably, the plate (3) with the above-described light deflecting structure satisfies the following relationship between the total Sa of projected areas found when the steep slopes (16) are projected to the light incoming surface (3a), and the total Sb of projected areas found when the gentle slopes (17) are projected to the light incoming surface (3a):

0.9≦Sa/Sb≦3.0.

In this case, it becomes possible to uniform the luminances of the respective light sources, so that the surface light source device can emit uniform light with far less nonuniformity in luminance.

Preferably, the following relationship is satisfied between the total E of projected areas found when the steep slopes (16) out of the slopes (14) inclined downward to the left, of the triangular ridges (6) are projected to the light incoming surface (3a), and the total F of projected areas found when the steep slopes (16) out of the slopes (15) inclined downward to the right, of the triangular ridges (6) are projected to the light incoming surface (3a):

0.9≦E/F≦1.1.

Also, preferably, the following relationship is satisfied between the total G of projected areas found when the gentle slopes (17) out of the slopes (14) inclined downward to the left, of the triangular ridges (6) are projected to the light incoming surface (3a), and the total H of projected areas found when the gentle slopes (17) out of the slopes (15) inclined downward to the right, of the triangular ridges (6) are projected to the light incoming surface (3a):

0.9≦G/H≦1.1.

In this case, the steep slopes (16) are formed at substantially the same proportions with respect to the slopes (14) inclined downward to the left and the slopes (15) inclined downward to the right. Similarly, the gentle slopes (17) are formed at substantially the same proportions with respect to the slopes (14) inclined downward to the left and the slopes (15) inclined downward to the right. Therefore, nonuniformity in luminance can be sufficiently suppressed.

Preferably, a projected length (Ua) and a projected length (Ub) are from 10 to 500 μm, wherein the projected length (Ua) is found when the length of the slope (14) inclined downward to the left in the inclining direction, of the triangular ridge (6) is projected to the light incoming surface (3a); and the projected length (Ub) is found when the length of the slope (15) inclined downward to the right in the inclining direction, of the triangular ridge (6) is projected to the light incoming surface (3a). When the respective projected lengths are set within this range, the lines which run along the vertexes of the triangular ridges (6) become invisible in visual observation.

Next, other specific structures relative to the plate (3) with the light deflecting structure will be described. That is, the plate (3) with the light deflecting structure may have any of the structures shown in FIGS. 4 to 11.

### Second Embodiment

In a plate (3) with a light deflecting structure according to the second embodiment shown in FIG. 4, first triangular ridges (6A) and second triangular ridges (6B) are disposed alternately on one surface (light outgoing surface) of the plate (3), wherein the first triangular ridge (6A) has an isosceles triangular section which is formed of a steep slope (16) as a slope (14) inclined downward to the left, and a steep slope (16) as a slope (15) inclined downward to the right; and the second triangular ridge (6B) has an isosceles triangular section which is formed of a gentle slope (17) as a slope (14) inclined downward to the left, and a gentle slope (17) as a slope (15) inclined downward to the right. The plate (3) with the light deflecting structure is so constituted as to satisfy a relationship of Sa=Sb.

### Third Embodiment

In a plate (3) with a light deflecting structure according to the third embodiment shown in FIG. 5, first triangular ridges (6A) and second triangular ridges (6B) are disposed alternately on one surface (light outgoing surface) of the plate (3), wherein the first triangular ridge (6A) has a triangular section which is formed of a steep slope (16) as a slope (14) inclined downward to the left, and a gentle slope (17) as a slope (15) inclined downward to the right; and the second triangular ridge (6B) has a triangular section which is formed of a gentle slope (17) as a slope (14) inclined downward to the left, and a steep slope (16) as a slope (15) inclined downward to the right. The plate (3) with the light deflecting structure is so constituted as to satisfy a relationship of Sa=Sb.

### Fourth Embodiment

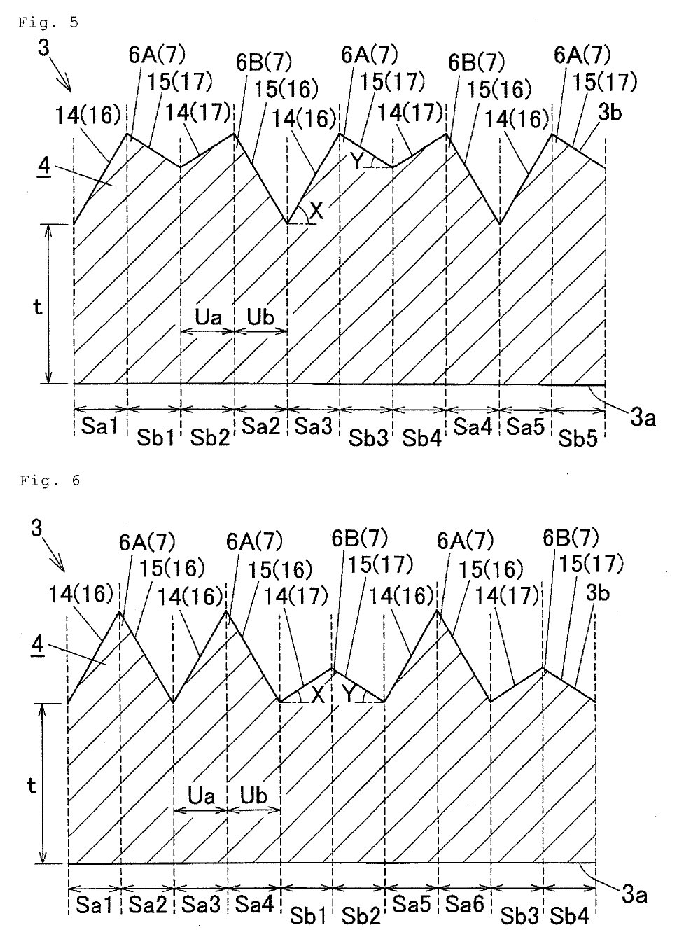

In a plate (3) with a light deflecting structure according to the fourth embodiment shown in FIG. 6, first triangular ridges (6A) and second triangular ridges (6B) are irregularly disposed on one surface (light outgoing surface) of the plate (3), wherein the first triangular ridge (6A) has an isosceles triangular section which is formed of a steep slope (16) as a slope (14) inclined downward to the left, and a steep slope (16) as a slope (15) inclined downward to the right; and the second triangular ridge (6B) has an isosceles triangular section which is formed of a gentle slope (17) as a slope (14) inclined downward to the left, and a gentle slope (17) as a slope (15) inclined downward to the right. However, the plate (3) with the light deflecting structure is so constituted as to satisfy a relationship of Sa=Sb.

### Fifth Embodiment

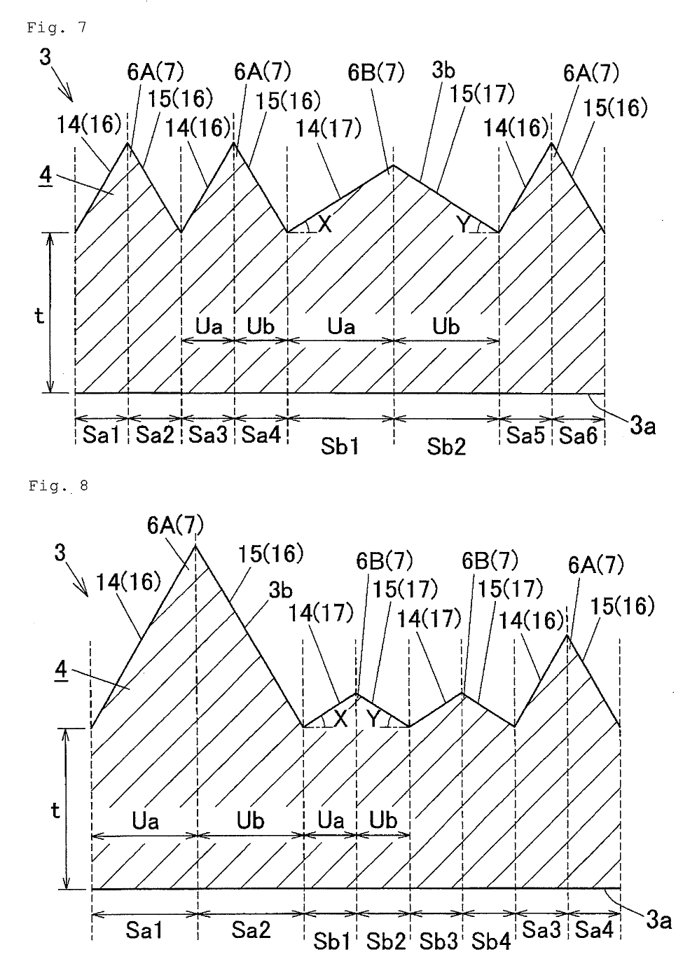

In a plate (3) with a light deflecting structure according to the fifth embodiment shown in FIG. 7, first triangular ridges (6A) and second triangular ridges (6B) are irregularly disposed on one surface (light outgoing surface) of the plate (3), wherein the first triangular ridge (6A) has an isosceles triangular section which is formed of a steep slope (16) as a slope (14) inclined downward to the left, and a steep slope (16) as a slope (15) inclined downward to the right; and the second triangular ridge (6B) has an isosceles triangular section which is formed of a gentle slope (17) as a slope (14) inclined downward to the left, and a gentle slope (17) as a slope (15) inclined downward to the right. The plate (3) with the light deflecting structure is so constituted as to satisfy a relationship of Ua of the second triangular ridge (6B)>Ua of the first triangular ridge (6A), and a relationship of Ub of the second triangular ridge (6B)>Ub of the first triangular ridge (6A). However, the plate (3) with the light deflecting structure is so constituted as to satisfy a relationship of Sa=Sb.

### Sixth Embodiment

In a plate (3) with a light deflecting structure according to the sixth embodiment shown in FIG. 8, first triangular ridges (6A) and second triangular ridges (6B) are irregularly disposed on one surface (light outgoing surface) of the plate (3), wherein the first triangular ridge (6A) has an isosceles triangular section which is formed of a steep slope (16) as a slope (14) inclined downward to the left, and a steep slope (16) as a slope (15) inclined downward to the right; and the second triangular ridge (6B) has an isosceles triangular section which is formed of a gentle slope (17) as a slope (14) inclined downward to the left, and a gentle slope (17) as a slope (15) inclined downward to the right. In some of the first triangular ridges (6A), a relationship of Ua of the first triangular ridge (6A)>Ua of the second triangular ridge (6B), and a relationship of Ub of the first triangular ridge (6A)>Ub of the second triangular ridge (6B) are satisfied. However, the plate (3) with the light deflecting structure is so constituted as to satisfy a relationship of Sa=Sb.

### Seventh Embodiment

In a plate (3) with a light deflecting structure according to the seventh embodiment shown in FIG. 9, a first triangular ridge (6A), a second triangular ridge (6B) and a third triangular ridge (6C) are repeatedly disposed in this order from the left side on one surface (light outgoing surface) of the plate (3), wherein the first triangular ridge (6A) has a triangular section which is formed of a steep slope (16) as a slope (14) inclined downward to the left, and a gentle slope (17) as a slope (15) inclined downward to the right; the second triangular ridge (6B) has an isosceles triangular section which is formed of a steep slope (16) as a slope (14) inclined downward to the left, and a steep slope (16) as a slope (15) inclined downward to the right; and the third triangular ridge (6C) has a triangular section which is formed of a gentle slope (17) as a slope (14) inclined downward to the left, and a steep slope (16) as a slope (15) inclined downward to the right. A relationship of Ua of the first triangular ridge (6A)=Ua of the second triangular ridge (6B)=Ua of the third triangular ridge (6C)=Ub of the first triangular ridge (6A)=Ub of the second triangular ridge (6B)=Ub of the third triangular ridge (6C) is satisfied. However, the plate (3) with the light deflecting structure is so constituted as to satisfy a relationship of Sa/Sb=2.

### Eighth Embodiment

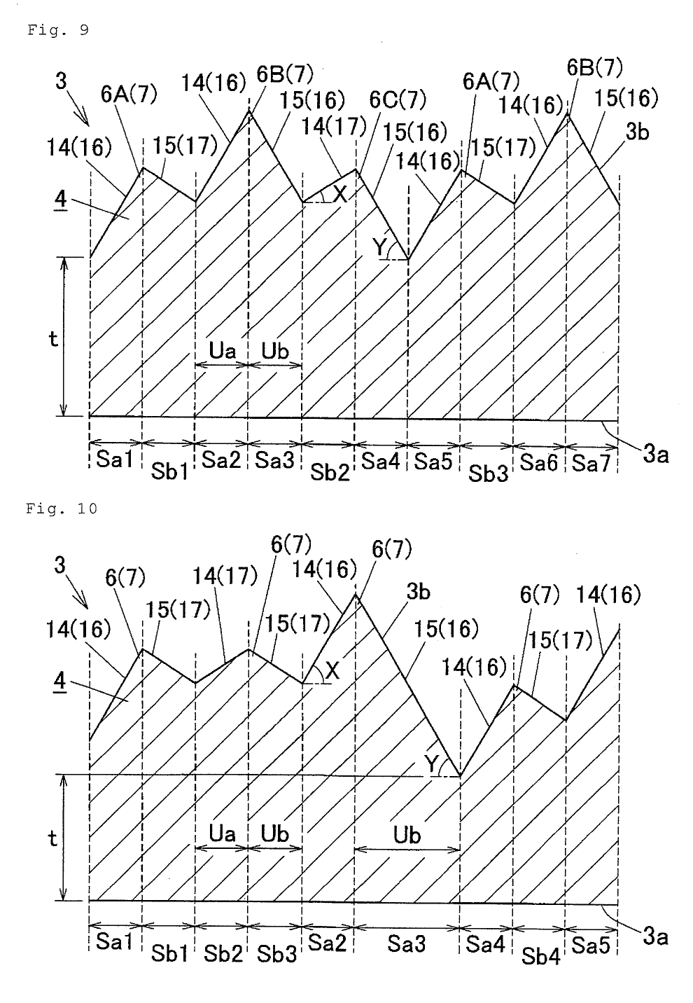

In a plate (3) with a light deflecting structure according to the eighth embodiment shown in FIG. 10, steep slopes (16) and gentle slopes (17) are disposed at random (or irregularly) on one surface (light outgoing surface) of the plate (3). There are steep slopes (16) which are inclined downward to the right and which have Ub different from Ub of other slopes.

### Ninth Embodiment

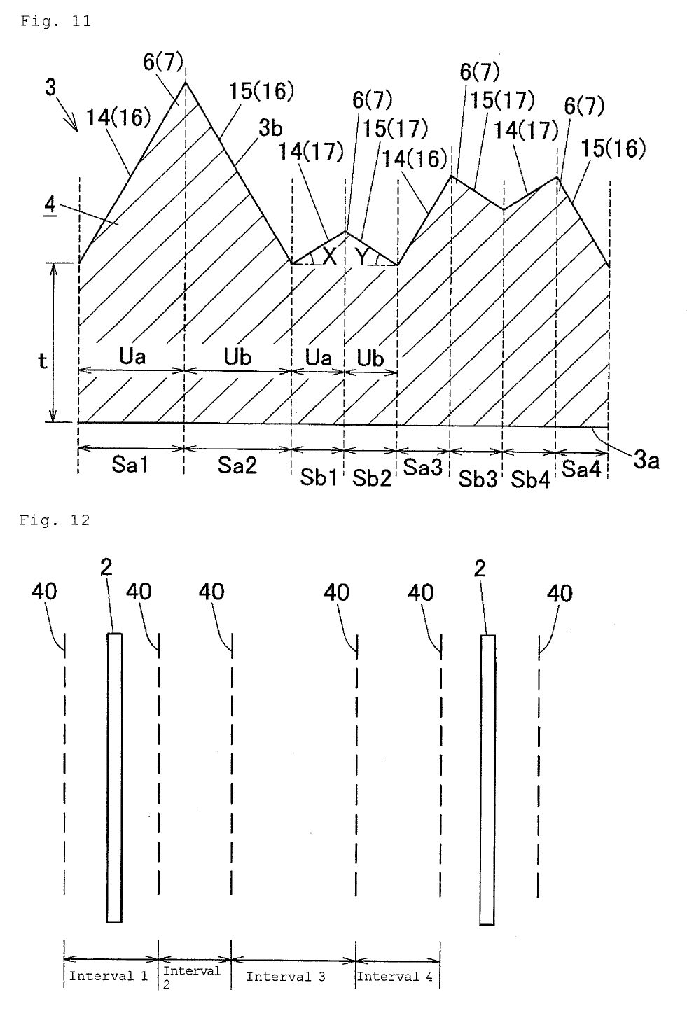

In a plate (3) with a light deflecting structure according to the ninth embodiment shown in FIG. 11, steep slopes (16) and gentle slopes (17) are disposed at random (or irregularly) on one surface (light outgoing surface) of the plate (3). There are steep slopes (16) which are inclined downward to the left and which have Ua different from Ua of other slopes; and there are steep slopes (16) which are inclined downward to the right and which have Ub different from Ub of other slopes.

In the present invention, the thickness (t) of the plate (3) with the above-described light deflecting structure is not limited. However, the thickness thereof is preferably from 0.1 to 10.0 mm. With the plate (3) having such a thickness, a surface light source device with a far thinner thickness can be provided, while uniformity in luminance being sufficiently obtained. The thickness (t) of the plate (3) with the above-described light deflecting structure is more preferably from 0.2 to 5.0 mm.

The method for manufacturing the plate (3) with the above-described light deflecting structure is not limited. For example, there may be employed any of extrusion, pressing, tooling, injection molding, a method using an activation energy curable resin composition, etc. When the plate (3) with the above-described light deflecting structure is manufactured by extrusion or pressing, for example, a plate having a prism pattern having triangular sections tooled thereon is used to replicate the prism pattern to the surface of a plate for a plate (3) with a light deflecting structure.

As the plate (3) with the above-described light deflecting structure, any of plates made of light-transmitting materials may be used. Examples of such a plate include a glass plate, an optical glass plate, a light-transmitting resin plate, etc. Examples of the light-transmitting resin plate include acrylic resin plates, polycarbonate plates, polystyrene plates, cyclic polyolefin plates, MS resin plates (methyl methacylate-styrene copolymer resin plates), ABS resin plates, AS resin plates (acrylonitrile-styrene copolymer resin plates), etc. Among those plates, a light-transmitting plate having a refractive index of from 1.45 to 1.60 is preferably used.

A deflecting function to change the direction of light is imparted to the above-described plate (3) with the light deflecting structure, by forming the above-characterized relief structure (4) on the light outgoing surface (3b) thereof. If needed, the plate itself may have a light-diffusing property. For example, the plate with the light deflecting structure may be shaped of a composition of light diffuser particles contained in a light-transmitting resin such as an acrylic resin or the like. Examples of the diffuser particles include resin particles such as polystyrene particles and silicone particles, and inorganic particles such as calcium carbonate particles, barium sulfate particles, titanium oxide particles and alumina particles. Alternatively, the plate with the light deflecting structure may be formed of an acrylic resin which contains particles having a refractive index anisotropy, oriented therein.

The above-described light sources (2) are not limited. For example, point light sources such as light-emitting diodes, etc. may be used, in addition to the linear light sources such as fluorescent lamps, halogen lamps, tungsten lamps, etc.

In the above-described embodiments (see FIGS. 3 to 11), the triangular ridges (6) of the plates (3) with the light deflecting structures are formed as the ridges (7) which extend along one direction in parallel to the surfaces of the plates (3) (one dimensional type) (see FIG. 2). However, the triangular ridges are not limited to one dimensional type: for example, the triangular ridges (6) of the plate (3) with the light deflecting structure are formed as the ridges (7) which extend along two directions in parallel to the surface of the plate (e.g., two directions orthogonal to each other) (two dimensional type).

In the above-described embodiments (see FIGS. 3 to 11), the triangular ridges (6) adjacent to each other are continuously formed. However, the triangular ridges are not limited to this structure: for example, a flat face may be present between each of the triangular ridges (6) adjacent to each other, in so far as the effect of the present invention is not impaired.

The above-described relief structure (4) may comprise triangular ridges other than the triangular ridges (6) with the above-described features, in so far as the effect of the present invention is not impaired.

The surface light source devices (1) and the liquid crystal displays (30) according to the present invention are not limited to the above-described embodiments, and any of alternations in design may be allowed, in so far as it does not depart from the spirit of the invention and is included in the scope of the claims.

### EXAMPLES

Next, concrete examples of the present invention will be described, which should not be construed as limiting the scope of the present invention in any way.

### Example 1

A MS resin (a methyl methacrylate-styrene copolymer resin having a refractive index of 1.57) was shaped into a plate, using an extruder, and then, the plate was subjected to heat press, using a patterned mold, so as to replicate a predetermined relief pattern to the plate. Thus, there was provided a plate (3) with a light deflecting structure shown in FIG. 4, with a thickness (t) of 2 mm, which had first triangular ridges (6A) and second triangular ridges (6B) formed alternately on its one surface (light outgoing surface) (see FIG. 4). The first triangular ridges (6A) were isosceles triangular ridges each of which had a slope (14) inclined downward to the left at an angle of X (an acute angle of 66.92°) (i.e., a steep slope 16) relative to the light incoming surface (3a), and a slope (15) inclined downward to the right at an angle of Y (an acute angle of 66.92°) (i.e., a steep slope 16) relative to the light incoming surface (3a). The second triangular ridges (6B) were isosceles triangular ridges each of which had a slope (14) inclined downward to the left at an angle of X (an obtuse angle of 38.29°) (i.e., a gentle slope 17) relative to the light incoming surface (3a), and a slope (15) inclined downward to the right at an angle of Y (an obtuse angle of 38.29°) (i.e., a gentle slope 17) relative to the light incoming surface (3a).

In addition, the plate (3) with the light deflecting structure had a structure satisfying a relationship of Sa/Sb=1 (see FIG. 4), wherein “Sa” was the total of projected areas found when the steep slopes (16) were projected to the light incoming surface (3a); and “Sb” was the total of projected areas found when the gentle slopes (17) were projected to the light incoming surface (3a).

Further, the plate (3) with the light deflecting structure had a structure satisfying relationships of E/F=1 and G/H=1 (see FIG. 4), wherein “E” was the total of projected areas found when the steep slopes (16), out of the slopes (14) inclined downward to the left, of the triangular ridges (6), were projected to the light incoming surface (3a); “F” was the total of projected areas found when the steep slopes (16), out of the slopes (15) inclined downward to the right, of the triangular ridges (6), were projected to the light incoming surface (3a); “G” was the total of projected areas found when the gentle slopes (17), out of the slopes (14) inclined downward to the left, of the triangular ridges (6), were projected to the light incoming surface (3a); and “H” was the total of projected areas found when the gentle slopes (17), out of the slopes (15) inclined downward to the right, of the triangular ridges (6), were projected to the light incoming surface (3a).

Furthermore, in the plate (3) with the light deflecting structure, the projected length (Ua) was 30 μm, which was found when the length of the slope (14) inclined downward to the left, of the triangular ridge (6) in the inclining direction was projected to the light incoming surface; and the projected length (Ub) was 30 μm, which was found when the length of the slope (15) inclined downward to the right, of the triangular ridge (6) in the inclining direction was projected to the light incoming surface (see FIG. 4).

A surface light source device (1) shown in FIG. 1 was assembled, using the plate (3) with the light deflecting structure. As light sources (2), fluorescent lamps were used. The distance (d) between the centers of the light sources (2) and the light incoming surface (3a) of the plate was set at 10 mm; and the distance (L) between each of the centers of the light sources (2), (2) adjacent to each other, at 40 mm. In this structure, the angle α determined by the above-described equation (1) was 66.92°; and the angle β determined by the above-described equation (3) was 38.29° (see Table 1).

### Examples 2 to 13 and Comparative Examples 2 to 4

Each surface light source device (1) was obtained in the same manner as in Example 1, except that the designing conditions were changed to those indicated in Table 1.

### Comparative Example 1

A surface light source device (1) was obtained in the same manner as in Example 1, except for a plate with a light deflecting structure which had a plurality of triangular ridges, each having an isosceles right triangular section, formed at pitch intervals of 50 μm on its light outgoing surface, wherein the apex angle was 90° (both two base angles: 45°); and the length of the base of the triangular ridge was 50 μm.

Each of the surface light source devices thus obtained was observed with respect to the positions (or distribution) of four light source images (40) (see FIG. 12) so as to find the intervals (1 to 4) among the four light source images (40). The results are shown in Table 1.

TABLE 1

| | | t | L | d | α | Inclination (°) of |
|---|---|---|---|---|---|---|
| | n | (mm) | (mm) | (mm) | (°) | steep slope |
| Ex. 1 | 1.57 | 2 | 40 | 10 | 66.92 | 66.92 |
| Ex. 2 | 1.57 | 2 | 40 | 10 | 66.92 | 66.00 |
| Ex. 3 | 1.57 | 2 | 40 | 10 | 66.92 | 68.50 |
| Ex. 4 | 1.57 | 2 | 35 | 8.75 | 66.71 | 66.71 |
| Ex. 5 | 1.57 | 2 | 35 | 10 | 64.34 | 64.34 |
| Ex. 6 | 1.57 | 2 | 30 | 10 | 60.92 | 60.92 |
| Ex. 7 | 1.57 | 1.5 | 35 | 10 | 64.78 | 64.78 |
| Ex. 8 | 1.57 | 1.5 | 35 | 10 | 64.78 | 63.00 |
| Ex. 9 | 1.59 | 0.1 | 40 | 8 | 69.86 | 69.86 |
| Ex. 10 | 1.59 | 2 | 35 | 10 | 63.00 | 63.00 |
| Ex. 11 | 1.59 | 0.1 | 35 | 10 | 64.58 | 64.58 |
| Ex. 12 | 1.59 | 0.1 | 35 | 8.75 | 66.83 | 66.83 |
| Ex. 13 | 1.49 | 3 | 30 | 10 | 65.42 | 65.42 |
| C. Ex. 1 | 1.57 | 2 | 40 | 10 | Isosceles triangular ridge | |
| | | | | | having apex angle of 90° | |
| C. Ex. 2 | 1.57 | 2 | 40 | 10 | 66.92 | 63.50 |
| C. Ex. 3 | 1.57 | 2 | 40 | 10 | 66.92 | 70.00 |
| C. Ex. 4 | 1.57 | 1.5 | 35 | 10 | 64.78 | 61.00 |

| | | | Interval | Interval | Interval | Interval |
|---|---|---|---|---|---|---|
| | β | Inclination (°) of | 1 | 2 | 3 | 4 |
| | (°) | gentle slope | (mm) | (mm) | (mm) | (mm) |
| Ex. 1 | 38.29 | 38.29 | 10.00 | 10.00 | 10.00 | 10.00 |
| Ex. 2 | 38.29 | 40.00 | 10.62 | 8.96 | 11.46 | 8.96 |
| Ex. 3 | 38.29 | 37.00 | 9.56 | 11.69 | 7.06 | 11.69 |
| Ex. 4 | 37.86 | 37.86 | 8.75 | 8.75 | 8.75 | 8.75 |
| Ex. 5 | 34.56 | 34.56 | 8.75 | 8.75 | 8.75 | 8.75 |
| Ex. 6 | 30.49 | 30.49 | 7.50 | 7.50 | 7.50 | 7.50 |
| Ex. 7 | 35.32 | 35.32 | 8.75 | 8.75 | 8.75 | 8.75 |
| Ex. 8 | 35.32 | 33.00 | 8.04 | 8.04 | 10.88 | 8.04 |
| Ex. 9 | 46.52 | 46.52 | 10.00 | 10.00 | 10.00 | 10.00 |
| Ex. 10 | 33.59 | 33.59 | 8.75 | 8.75 | 8.75 | 8.75 |
| Ex. 11 | 36.49 | 36.49 | 8.75 | 8.75 | 8.75 | 8.75 |
| Ex. 12 | 40.20 | 40.20 | 8.75 | 8.75 | 8.75 | 8.75 |
| Ex. 13 | 33.06 | 33.06 | 7.50 | 7.50 | 7.50 | 7.50 |
| C. Ex. 1 | Isosceles triangular ridge | | 12.60 | — | 27.40 | — |
| | having apex angle of 90° | | | | | |
| C. Ex. 2 | 38.29 | 35.00 | 8.90 | 8.17 | 14.76 | 8.17 |
| C. Ex. 3 | 38.29 | 42.50 | 11.56 | 12.42 | 3.60 | 12.42 |
| C. Ex. 4 | 35.32 | 32.00 | 7.74 | 7.16 | 12.94 | 7.16 |

As was apparent from Table 1, in any of the surface light source devices of Examples 1 to 13 of the present invention, the four light source images were formed (or distributed) at substantially even intervals, and thus, uniform light with high uniformity in luminance could be emitted. That is, in any of Examples 1, 4 to 7 and 9 to 13 in which the inclination of the steep slope was set at the same value as α, and the inclination of the gentle slope, at the same value as β, the intervals (the intervals 1 to 4) among each of the four light source images were perfectly even. In any of Examples 2, 3 and 8 in which the inclination of the steep slope was set within a range of α±3°, and the inclination of the gentle slope, within a range of β±3°, the intervals (the intervals 1 to 4) among each of the four light source images were substantially even, in other words, within a range of the perfectly even interval ±25%. For example, in Example 2, the ideal perfectly even interval was 10.00 mm (refer to Example 1), whereas the longest interval (the interval 3) was 11.46 mm, which was included within a range of the perfectly even interval ±25%.

In contrast, in Comparative Example 1, using the plate with the light deflecting structure on which the triangular ridges each having an isosceles right triangular section with an apex angle of 90° (two base angles: 45°), it was impossible to obtain substantially even intervals. In any of Comparative Examples 2 to 4 in which the inclinations of the steep slope and the gentle slope were outside the range defined in the present invention, any one of the intervals (1 to 4) among each of the four light source images was outside the range of the perfectly even interval ±25%. For example, in Comparative Example 2, the ideal perfectly even interval was 10.00 mm (refer to Example 1), whereas the longest interval (the interval 3) was 14.76 mm, which was outside the range of the perfectly even interval ±25%. Also, in Comparative Example 3, the ideal perfectly even interval was 10.00 mm (refer to Example 1), whereas the shortest interval (the interval 3) was 3.60 mm, which was outside the range of the perfectly even interval ±25%.

### INDUSTRIAL APPLICABILITY

While any of the surface light source devices of the present invention is preferably used as a backlight for a liquid crystal display, the application thereof is not limited to such.

What is claimed is:

1. A surface light source device comprising a plurality of light sources spaced from one another, and a plate with a light deflecting structure which is disposed on the front side of the light sources to change the direction of light emitted from the light sources, characterized in that
said plate with the light deflecting structure consists of a light-transmitting plate having a relief structure formed on its light outgoing surface, said relief structure comprising a plurality of triangular ridges with triangular sections;
said triangular ridges have slopes inclined downward to the left and slopes inclined downward to the right,
said slopes inclined downward to the left including steep slopes satisfying a relationship of
α−3°≦X≦α+3°,
wherein “X” is an inclination angle (an acute angle) of the slope inclined downward to the left, relative to the light incoming surface; and α is an angle determined by the following equation (1), and
gentle slopes satisfying a relationship of
β−3°≦X≦β+3°,
wherein β is an angle determined by the following equation (3); and
said slopes inclined downward to the right including steep slopes satisfying a relationship of
α−3°≦Y≦α+3°,
wherein “Y” is an inclination angle (an acute angle) of the slope inclined downward to the right, relative to the light incoming surface, and
gentle slopes satisfying a relationship of
β−3°≦Y≦β+3°:
$$\begin{matrix}[ Equation 1 ] & \\ α = {Tan}^{- 1} ( \frac{sin {j}_{a}}{cos {j}_{a} - 1 / n} ) & ( 1 )\end{matrix}$$
(wherein jαis an angle satisfying the following equation (2)):
$$\begin{matrix}[ Equation 2 ] & \\ {Sin}^{- 1} ( n \cdot sin {j}_{a} ) = {Tan}^{- 1} \{ \frac{1}{d} ( \frac{3 L}{8} - t \cdot tan {j}_{a} ) \} & ( 2 ) \\ [ Equation 3 ] & \\ β = {Tan}^{- 1} ( \frac{sin {j}_{b}}{cos {j}_{b} - 1 / n} ) & ( 3 )\end{matrix}$$
(wherein j_{b} is an angle satisfying the following equation (4)):
$$\begin{matrix}[ Equation 4 ] & \\ {Sin}^{- 1} ( n \cdot sin {j}_{b} ) = {Tan}^{- 1} \{ \frac{1}{d} ( \frac{L}{8} - t \cdot tan {j}_{b} ) \} & ( 4 )\end{matrix}$$
(wherein, in the equations (1) to (4), n is the refractive index of the triangular ridge; L is the distance between each of the centers of the light sources adjacent to each other; d is the distance between the centers of the light sources and the light incoming surface of the plate with the light deflecting structure; and t is the thickness of the plate with the light deflecting structure).

2. The surface light source device of claim 1, characterized in that the following relationship is satisfied:
0.9≦Sa/Sb≦3.0,
wherein “Sa” is the total of projected areas found when the steep slopes are projected to the light incoming surface; and “Sb” is the total of projected areas found when the gentle slopes are projected to the light incoming surface.

3. The surface light source device of claim 1 or 2,
characterized in that the following relationship is satisfied:
0.9≦E/F≦1.1,
wherein
“E” is the total of projected areas found when the steep slopes out of the slopes inclined downward to the left of the triangular ridges are projected to the light incoming surface; and
“F” is the total of projected areas found when the steep slopes out of the slopes inclined downward to the right of the triangular ridges are projected to the light incoming surface; and
the following relationship is satisfied:
0.9≦G/H≦1.1,
wherein
“G” is the total of projected areas found when the gentle slopes out of the slopes inclined downward to the left of the triangular ridges are projected to the light incoming surface; and
“H” is the total of projected areas found when the gentle slopes out of the slopes inclined downward to the right of the triangular ridges are projected to the light incoming surface.

4. The surface light source device of claim 1 or 2, wherein a projected length is from 10 to 500 μm, which is found when the length of the slope inclined downward to the left in the inclining direction, of the triangular ridge is projected to the light incoming surface; and a projected length is from 10 to 500 μm, which is found when the length of the slope inclined downward to the right in the inclining direction, of the triangular ridge is projected to the light incoming surface.

5. The surface light source device of claim 1 or 2, wherein said plate with the light deflecting structure contains light diffuser particles, and the light incoming surface of said plate with the light deflecting structure is formed smooth.

6. The surface light source device of claim 1 or 2, wherein the light incoming surface of said plate with the light deflecting structure is matted.

7. A liquid crystal display, characterized in that a surface light source device defined in claim 1 or 2 is disposed on the rear side of a liquid crystal panel.
